(19) United States
(12) Patent Application Publication
(10) Pub. No.: US 2019/0004361 A1
(43) Pub. Date: Jan. 3, 2019

(54) DISPLAY DEVICE

(71) Applicant: Japan Display Inc., Tokyo (JP)

(72) Inventors: Shinichiro Oka, Tokyo (JP); Yosuke Hyodo, Tokyo (JP); Lu Jin, Tokyo (JP)

(21) Appl. No.: 16/012,880

(22) Filed: Jun. 20, 2018

(30) Foreign Application Priority Data
Jul. 3, 2017 (JP) 2017-130399

(51) Int. Cl. G02F 1/1333; G02F 1/1335

(52) U.S. Cl. CPC G02F 1/133305; G02F 1/133536; G02F 1/133528

(57) ABSTRACT

A display device having flexibility and including a display cell including a first substrate having flexibility, a second substrate having flexibility and an electro-optical layer between the first substrate and the second substrate, a first film adhered to the display cell on the first substrate side, a first polarization member between the first substrate and the first film, and a second film adhered to the display cell on the second substrate side. The first film may be on a surface of the display device.

### CROSS REFERENCE TO RELATED APPLICATIONS

This application is based upon and claims the benefit of priority from the prior Japanese Patent Application No. 2017-130399, filed on Jul. 3, 2017, the entire contents of which are incorporated herein by reference.

### FIELD

One embodiment of the present invention is related to a display device. In particular, one embodiment of the present invention is related to a liquid crystal display device having flexibility.

### BACKGROUND

Flexible display devices are expected to be widely applied as mobile scroll type displays or screen type large screen display devices. The realization of flexible display devices is strongly desired as next-generation display devices that are lightweight and have excellent storage capabilities. A liquid crystal display element can be applied to either a transmissive type or a reflective type display system. Therefore, a flexible display device which uses a liquid crystal display element has excellent visibility in various lighting environments.

In recent years, the development of a foldable display device having a display region which can be bent has been advanced as one type of flexible display device. In a foldable display device, a cover film having flexibility is used instead of a cover glass which is normally used for a display device so as to be bendable in the display area. A film having a structure in which a hard coat such as acrylic or urethane is attached to a film such as a polyimide film or a PET film is used as the cover film (for example, see Japanese Laid Open Patent Application No. 2017-013492 and Japanese Laid Open Patent Application No. 2015-069197). This cover film is bonded to a display cell via, for example, a UV curable resin or the like.

### SUMMARY

A display device in an embodiment according to the present invention includes a display cell including a first substrate having flexibility, a second substrate having flexibility and an electro-optical layer between the first substrate and the second substrate, a first film adhered to the display cell on the first substrate side, a first polarization member between the first substrate and the first film, and a second film adhered to the display cell on the second substrate side.

A display device in an embodiment according to the present invention includes a display cell including a first substrate having flexibility, a second substrate having flexibility and an electro-optical layer between the first substrate and the second substrate, a first film adhered to the display cell on the first substrate side, and a first polarization member between the first substrate and the first film, wherein a neutral face of stress when the display device is bent is in the first substrate, in the second substrate or between the first substrate and the second substrate.

### BRIEF DESCRIPTION OF DRAWINGS

FIG. 1 is a cross-sectional diagram showing an overall structure of a liquid crystal display device related to one embodiment of the present invention;

FIG. 2 is a planar view diagram showing an overall structure of a liquid crystal display device related to one embodiment of the present invention;

FIG. 3 is a cross-sectional diagram showing an overall structure of a liquid crystal display device related to one embodiment of the present invention;

FIG. 4 is a cross-sectional diagram showing an overall structure of a liquid crystal display device related to one embodiment of the present invention;

FIG. 5 is a cross-sectional diagram showing a layer structure of a second polarization member related to one embodiment of the present invention;

FIG. 6 is a cross-sectional diagram showing an overall structure of a liquid crystal display device related to one embodiment of the present invention;

FIG. 7 is a cross-sectional diagram showing a layer structure of a second polarization member related to one embodiment of the present invention;

FIG. 8 is a cross-sectional diagram showing an overall structure of a liquid crystal display device related to one embodiment of the present invention;

FIG. 9 is a diagram for explaining a neutral face in one embodiment of the present invention;

FIG. 10 is a cross-sectional diagram showing a neutral face in the state of a conventional liquid crystal display cell;

FIG. 11 is a cross-sectional diagram showing a neutral face in the state of a conventional liquid crystal display panel; and

FIG. 12 is a cross-sectional diagram showing a neutral face in the state of a conventional liquid crystal display device.

### DESCRIPTION OF EMBODIMENTS

Each embodiment of the present invention is explained below while referring to the drawings. Furthermore, the disclosure is merely an example, and a structure which could be easily conceived by a person skilled in the art by appropriate modification without departing from the gist of the invention is naturally contained in the scope of the present invention. Although the drawings may be schematically represented in terms of width, thickness or shape of each part as compared with their actual mode in order to make explanation clearer, it is only an example and an interpretation of the present invention is not limited. In the present specification and each drawing, the same reference numerals followed by a letter of the alphabet are provided to the same elements as those described previously with reference to preceding figures and a detailed explanation may be omitted accordingly.

In each embodiment of the present invention, the direction from the first substrate on which the transistor is arranged toward a second substrate which faces the first substrate is referred to as downward, lower or lower side. Reversely, the direction from the second substrate toward the first substrate is referred to as upward, upper or upper side. In this way, although an explanation is given using the phrase “upward” or “downward” for the sake of convenience of explanation, for example, it may be arranged so that the vertical relationship between the first substrate and the second substrate is the reverse of that shown in the drawing. In the following explanation, the expression “the second substrate on the first substrate” merely explains the vertical relationship between the first substrate and the second substrate as described above, and other members may also be arranged between the first substrate and the second substrate.

The terms “inner side” and “outer side” show the relative positional relationship with respect to a display part in the two parts. “Inner side” indicates the side closer to the display part relative to one part. “Outer side” indicates the side farther from the display relative to one part. However, the definitions of “inner side” and “outer side” here are assumed to be in a state in which the display device is not bent.

“Display device” indicates a structure which displays an image using an electro-optical layer. For example, the term “display device” indicates a structure in which another optical member (for example, a polarization member, an illumination device or a touch panel and the like) is attached to a display cell. Furthermore, the term display cell indicates a structure including a first substrate arranged with a transistor, a second substrate arranged facing the first substrate, and an electro-optical layer between the first substrate and the second substrate. The term “display panel” indicates a structure in which a polarization member and a cover film on a surface of the viewer side of a display cell are attached to the display cell. The “electro-optical layer” may include a liquid crystal layer, an electroluminescence (EL) layer (including an LED layer), an electrochromic (EC) layer and an electrophoretic layer, as long as no technical inconsistency occurs. Therefore, with respect to the embodiments described later, although a liquid crystal display device including a liquid crystal layer is explained as an example of a display device, the application to a display device including other electro-optical layers as described above is not excluded.

In the present specification, the expressions “a includes A, B or C”, “a includes any one of A, B, and C” and “a includes one selected from a group comprised from A, B and C” does not exclude the case where a includes a plurality of combinations of A to C unless otherwise specified. Furthermore, these expressions do not exclude the case where a includes other elements.

In view of the above circumstances, an object of one embodiment of the present invention is to provide a display device having high durability against bending.

### First Embodiment

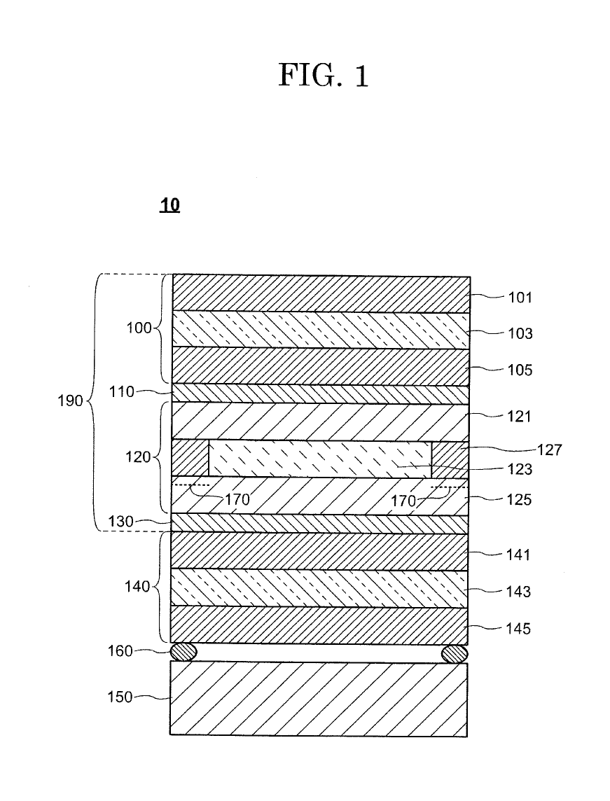

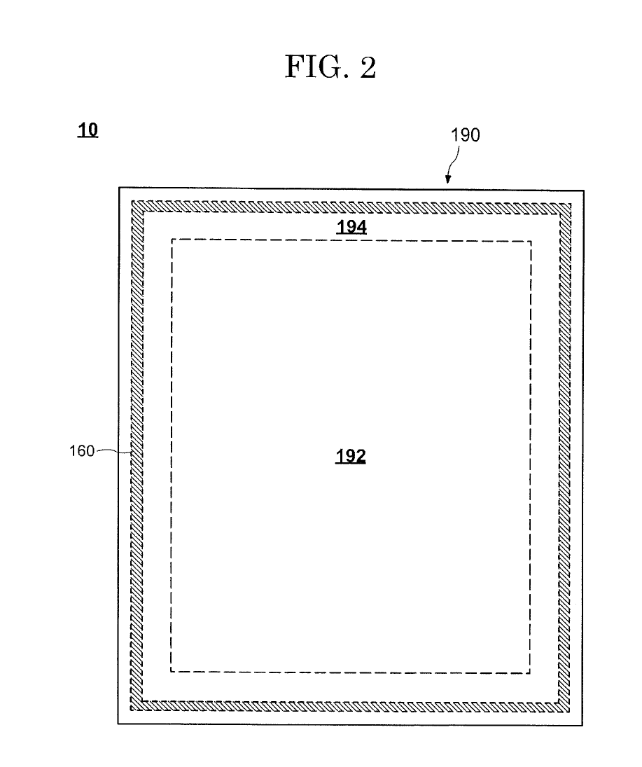

An outline of a liquid crystal display device according to one embodiment of the present invention is explained using FIG. 1 and FIG. 2. In the first embodiment, an example of a display device is explained using a liquid crystal display device (LCD). However, the present invention can also be used for display devices such as an organic EL device (Organic Light-Emitting Diode; OLED) or electronic paper in addition to a liquid crystal display device.

### [Structure of Display Device 10]

FIG. 1 is a cross-sectional diagram showing an overall structure of a liquid crystal display device according to one embodiment of the present invention. As is shown in FIG. 1, the display device 10 includes a first film 100, a first polarization member 110, a display cell 120, a second polarization member 130, a second film 140 and an illumination device 150. Any one of these members has flexibility. That is, the display device 10 has flexibility and can be folded. The first film 100 and the first polarization member 110, the first polarization member 110 and the display cell 120, the display cell 120 and the second polarization member 130, and the second polarization member 130 and the second film 140 are adhered to each other.

Here, two members being adhered to each other means that both are adhered on almost the entire surface. However, it is not limited to a structure in which opposing surfaces of the two members are completely adhered to each other over the entire surface. This expression also includes a structure in which both are adhered to each other to an extent so that a neutral face of the display device is affected when the display device is bent by adhesion of the two members. For example, this expression may also include a structure in which 70 percent or more of opposing surfaces of the two members to be adhered are adhered to each other. That is, this expression may also include a structure in which there are regions that are not locally adhered on opposing surfaces of the two members to be adhered.

A first film 100 is adhered to the first substrate 121 of the display cell 120 via the first polarization member 110. In other words, the first film 100 is adhered to the first substrate 121 side of the display cell 120. The first film 100 exists on the surface of the display device 10. The second film 140 is adhered to the second substrate 125 of the display cell 120 via the second polarization member 130. In other words, the second film 140 is adhered to the second substrate 125 side of the display cell 120. Although a structure is exemplified in the present embodiment in which the first film 100 exists on the surface of the display device 10, other members may also exist on the first film 100. That is, the first film 100 may not exist on the surface of the display device 10.

The first film 100 has hard coats 101, 105 and a base material 103. The base material 103 is sandwiched by the hard coats 101, 105. Similarly, the second film 140 has hard coats 141, 145 and a base material 143. The base material 143 is sandwiched by the hard coats 141 and 145.

In the present embodiment, the thicknesses of the base materials 103 and 143 are about 50 μm, and the thicknesses of the hard coats 101, 105, 141 and 145 are about 30 μm. That is, the thickness of each of the first film 100 and the second film 140 is about 110 μm. However, these thicknesses are one example of the present embodiment and the thicknesses of the first film, the second film, the base material and the hard coats of the present invention are not limited to the thicknesses described above. For example, the thickness of the base materials 103, 143 may be 20 μm or more and 100 μm or less. Similarly, the thickness of the hard coats 101, 105, 141 and 145 may be 10 μm or more and 80 μm or less. The thickness of the base material 103 may be larger than the thicknesses of the hard coats 101 and 105. The thickness of the base material 143 may be larger than the thickness of the hard coats 141, 145. In addition, the total thickness of the hard coats 101 and 105 may be larger than the thickness of the base material 103. The total thickness of the hard coats 141 and 145 may be larger than the thickness of the base material 143.

A material having a predetermined Martens hardness is used as the hard coat in order to provide excellent hardness to the first film 100. For example, it is possible to use the materials described in Japanese Laid Open Patent Publication No. 2017-013492 and No. 2015-069197 as the hard coat. In the present embodiment, the first film 100 and the second film 140 have the same structure. That is, the hard coats 101, 105 and the hard coats 141, 145 are made of the same material. The base material 103 and the base material 143 are made of the same material. In other words, the skeleton of the main material of the base material 103 of the first film 100 is the same as the skeleton of the main material of the base material 143 of the second film 140. However, as is described herein, the first film 100 and the second film 140 may also have different structures. That is, the skeleton of the main material of the base material 103 and the skeleton of the main material of the base material 143 may be different. The first film 100 and the second film 140 may be made of the same material and the thicknesses of the hard coat 101 and the hard coat 141 may be different, the thicknesses of the hard coat 105 and the hard coat 145 may also be different, and the thicknesses of the base material 103 and the base material 143 may also be different.

The display cell 120 includes a first substrate 121, a liquid crystal layer 123 and a second substrate 125. The first substrate 121 and the second substrate 125 are fixed together via a sealing material 127. The sealing material 127 is arranged continuously along the outer periphery of the first substrate 121 or the second substrate 125. The liquid crystal layer 123 is arranged between the first substrate 121 and the second substrate 125. In other words, the liquid crystal layer 123 is sealed in a space surrounded by the first substrate 121, the second substrate 125 and the sealing material 127. The second substrate 125 includes transistors and wiring. The transistors and wiring are formed by a metal layer, a semiconductor layer and an inorganic insulating layer. A pixel circuit and a drive circuit for driving the pixel circuit are formed by the transistors and the wiring. The first substrate 121 includes a color filter. However, the color filter may also be arranged on the second substrate 125. The first substrate 121 and the second substrate 125 may be interchanged. In other words, the second substrate 125 may also be arranged on the first substrate 121, the second polarization member 130 may be adhered to the first substrate 121, and the first polarization member 110 may be adhered to the second substrate 125.

The first polarization member 110 and the second polarization member 130 are members that polarize light in a specific direction or only allow polarized light to pass through. The first polarization member 110 and the second polarization member 130 may be plate-shaped such as a conventional polarization plate or may be a film-like member. In the case when the first polarization member 110 and the second polarization member 130 are plate-shaped, it is preferred that the plate-shaped member has flexibility sufficient to allow the display device 10 to be bent. It is possible to use a transmission type polarization member as the first polarization member 110. A reflective type polarization member can be used as the second polarization member 130. That is, a polarization member including a reflective film can be used as the second polarization member 130.

In the present embodiment, the thickness of each of the first polarization member 110 and the second polarization member 130 is 10 μm or less. However, the thickness described above is one example of the present embodiment and the thickness of the polarization members of the present invention is not limited to the thicknesses described above.

In the present embodiment, it is possible to use APCF manufactured by Nitto Denko Corporation or DBEF manufactured by 3M Co., Ltd. as the reflection type polarization member. Although the first polarization member 110 and the second polarization member 130 have the same structure in the present embodiment, as described herein, the first polarization member 110 and the second polarization member 130 may also have different structures.

The first film 100, the first polarization member 110, the display cell 120 and the second polarization member 130 can be collectively called a display panel 190. In other words, the second film 140 is adhered to the display panel 190 on the second polarization member 130 side of the display panel 190.

The illumination device 150 is fixed to the second film 140 via an adhesive 160. In other words, the second film 140 exists between the illumination device 150 and the second polarization member 130. In other words, the illumination device 150 is fixed to the second polarization member 130 side of the display panel 190 via the adhesive 160. A gap is arranged between the second film 140 and the illumination device 150. Although described in detail herein, the adhesive 160 is arranged along the periphery of the illumination device 150 or the second film 140.

The illumination device 150 includes a light source and a light guide member. Light which is emitted from the light source is supplied to the display panel 190 by the light guide member. The light source of the illumination device 150 may be a point light source or a surface light source. A light guide plate which is thinner than a conventional light guide plate may be used as the illumination device 150 having flexibility. The light guide plate divided into a plurality of pieces may be used as the illumination device 150. An OLED having flexibility may be used as a light source of the illumination device 150. A direct type backlight in which a micro LED may be used as a light source of the illumination device 150.

A region where the adhesive 160 is arranged is explained using FIG. 2. FIG. 2 is a planar view diagram showing the overall structure of a liquid crystal display device according to one embodiment of the present invention. FIG. 2 is a planar view of the display panel 190 viewed from above (first film 100 side). As is shown in FIG. 2, the display panel 190 includes a display region 192 for displaying an image and a periphery region 194 on the periphery of the display region 192. Although not shown in FIG. 2, the sealing material 127 shown in FIG. 1 is arranged in the periphery region 194. The display region 192 is a region where the sealing material 127 is not arranged. The adhesive 160 is arranged in the periphery region 194 in a planar view in order to form an air layer between the display panel 190 and the illumination device 150. In other words, the adhesive 160 continuously surrounds the outer side of the display region 192. In other words, the adhesive 160 is arranged in a region which does not overlap with a part of the display region 192 in a planar view. Although the adhesive 160 is not arranged in the display region 192 in FIG. 2, the adhesive 160 may be arranged in a part of the display region 192. For example, the adhesive 160 may be arranged in a region where light from the illumination device 150 is not transmitted to the viewer side, that is, in a region where a light shielding layer is arranged in the display region 192.

### [Explanation of Neutral Face]

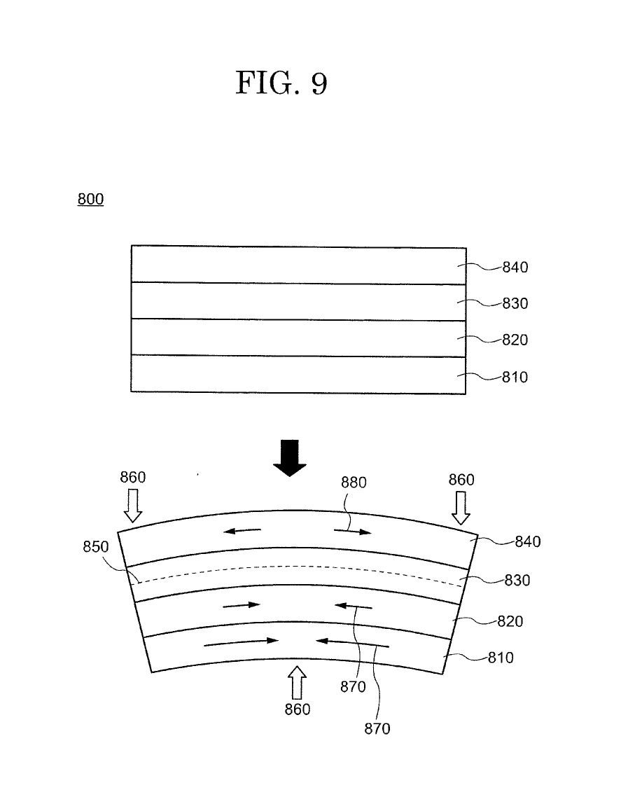

A neutral face in a foldable display device is explained using FIG. 9 in order to explain the operational effects which are obtained by the structure of the display device 10 according to one embodiment of the present invention. FIG. 9 is a diagram for explaining a neutral face in one embodiment of the present invention. As is shown in FIG. 9, a neutral face 850 is explained using a stacked structure 800 in which a first layer 810, second layer 820, third layer 830 and fourth layer 840 are stacked. As is shown in FIG. 9, when the stacked structure 800 is bent so that the center part of the stacked structure 800 is convex in an upward direction due an external force 860, a compression stress 870 occurs in a direction in which each layer shrinks in the first layer 810 and the second layer 820 which are arranged on a surface side on which a concave surface is formed due to bending. On the other hand, a tensile stress 880 occurs in the direction in which the layer extends in the fourth layer 840 which is arranged on a surface side formed with a convex surface due to bending. A surface where the compression stress 870 and tensile stress 880 are reversed is the neutral face 850. Stress does not occur in an ideal neutral face 850. That is, if a metal layer, semiconductor layer and an inorganic insulating layer are arranged near the neutral face 850, it is possible to prevent these layers from breaking due to stress.

The position of the neutral face 850 in the thickness direction of each layer is different depending on the layer structure. Specifically, the position of the neutral face 850 described above depends on bending rigidity. Bending rigidity refers to the degree of difficulty in dimension change (deformation) with respect to a bending force.

### [Conventional Problem]

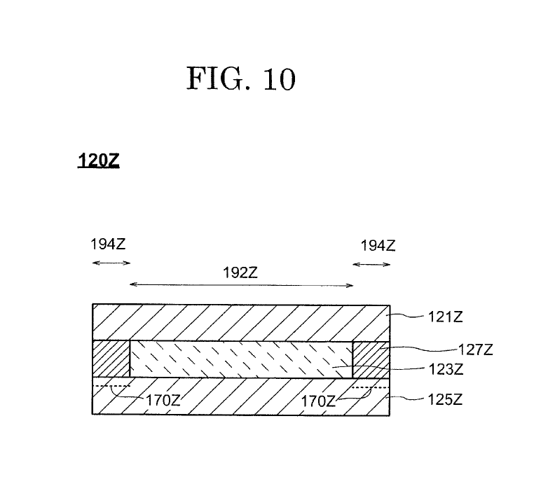

The neutral face at the bent part of a periphery region 194Z (in particular, the region overlapping the sealing material 127Z in a planar view) when a conventional display device is folded is explained using FIG. 10 to FIG. 12. In the following explanation, unless otherwise noted, “neutral face” indicates the neutral face of the periphery region 194Z.

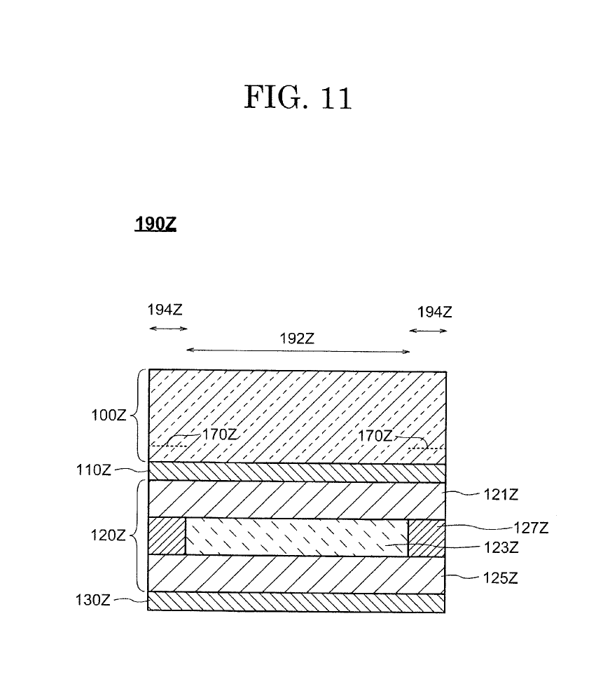

FIG. 10 is a cross-sectional diagram showing a neutral face in a conventional liquid crystal display cell. The display cell 120Z shown in FIG. 10 is in a state before the first polarization member 110Z and the second polarization member 130Z shown in FIG. 11 are formed. In the display cell 120Z shown in FIG. 10, the neutral face 170Z exists in the first substrate 121Z, in the second substrate 125Z, or between the first substrate 121Z and the second substrate 125Z. Since layers having high rigidity such as a metal layer, a semiconductor layer and an inorganic insulating layer are arranged in the second substrate 125Z, the rigidity of the second substrate 125Z is higher than the rigidity of the first substrate 121Z. As a result, as is shown in FIG. 10, the neutral face 170Z often exists on the second substrate 125Z.

FIG. 11 is a cross-sectional diagram showing a neutral face in a state of a conventional liquid crystal display panel. In the display panel 190Z shown in FIG. 11, the first polarization member 110Z and the first film 100Z are arranged on the first substrate 121Z side of the display cell 120Z shown in FIG. 10, and the second polarization member 130Z is arranged on the second substrate 125Z side of the display cell 120Z. In the case where the rigidity of the first polarization member 110Z and the rigidity of the second polarization member 130Z are the same, or in the case where there is no significant difference between the first polarization member 110Z and the second polarization member 130Z, the position of the neutral face 170Z does not significantly change just by adhering the first polarization member 110Z and the second polarization member 130Z to the display cell 120Z. However, in the display panel 190Z, since the first film 100Z is adhered to the first substrate 121Z side of the display cell 120Z, the neutral face 170Z is significantly shifted towards the first film 100Z. As a result, the neutral face 170Z exists within the first film 100Z and not in the display cell 120Z.

In the case when the display panel 190Z is bent in the state described above, a large stress is applied to the wiring layer in the periphery region 194Z of the second substrate 125Z where the wiring layers are arranged compactly. The wiring layers may be damaged by this stress. On the other hand, since the liquid crystal layer 123Z has fluidity, the neutral face of the display region 192Z (region which does not overlap with the sealing material 127Z in a planar view) is not affected by the first film 100Z.

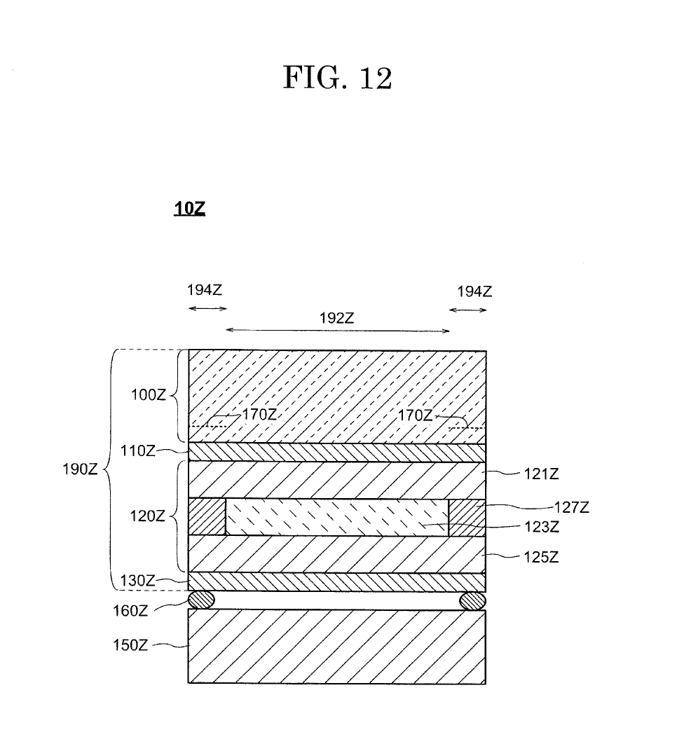

FIG. 12 is a cross-sectional diagram showing a neutral face in a state of a conventional liquid crystal display device. In the display device 10Z shown in FIG. 12, the illumination device 150Z is fixed to the second polarization member 130Z side of the display panel 190Z shown in FIG. 11 via the adhesive 160Z. Although the display device 10 shown in FIG. 1 is similar to the display device 10Z shown in FIG. 12, the display device 10 is different from the device 10Z in that the second film 140 is adhered to the second polarization member 130 side of the display panel 190.

As is shown in FIG. 12, since the adhesive 160Z is arranged only in one part of the periphery region 194Z of the display panel 190Z, the illumination device 150Z has almost no effect on the position of the neutral face 170Z of the display region 192Z. Apart from the case where the adhesive 160Z is thickly formed, the position of the neutral face 170Z of the display device 10Z which is attached with the illumination device 150Z is substantially the same as the position of the neutral face 170Z of the display panel 190Z shown in FIG. 11. That is, the neutral face 170Z of the display device 10Z exists in the first film 100Z but not within the display cell 120Z. When the display device 10Z is bended in the state shown in FIG. 12, a large stress is applied to the metal layer, the semiconductor layer and the inorganic insulating layer (in particular, the wiring layer of the periphery region 194Z) in the second substrate 125Z. Furthermore, in the case where the adhesive layer 160 is formed thickly, the adhesive layer 160 assists control of the neutral face of the second film 140 in the periphery region 194Z. Therefore, the adhesive layer 160 may be formed thickly.

### [Neutral Face of First Embodiment]

Unlike the conventional display device 10Z explained above, in the display device 10 (FIG. 1) according to the first embodiment, since the second film 140 is adhered to the second polarization member 130 side of the display panel 190, the neutral face 170 of the display device 10 exists within the display cell 120 (in the first substrate 121, in the second substrate 125, or between the first substrate 121 and the second substrate 125). Therefore, even when the display device 10 is bended, it is possible to suppress stress from being applied to the metal layer, the semiconductor layer and the inorganic insulating layer of the second substrate 125 in the periphery region 194 which overlaps the sealing material 127 in a planar view in particular.

Although an example was shown in the present embodiment in which the neutral face of the periphery region 194 exists within the display cell 120 by adhering the second film 140, in an OLED in which the light emitting element of an organic EL is sealed solid for example, it is possible to obtain a structure in which the neutral face of the entire surface of the OLED exists within the display cell 120 by adhering the second film 140. This is also the same in the following embodiments.

### Second Embodiment

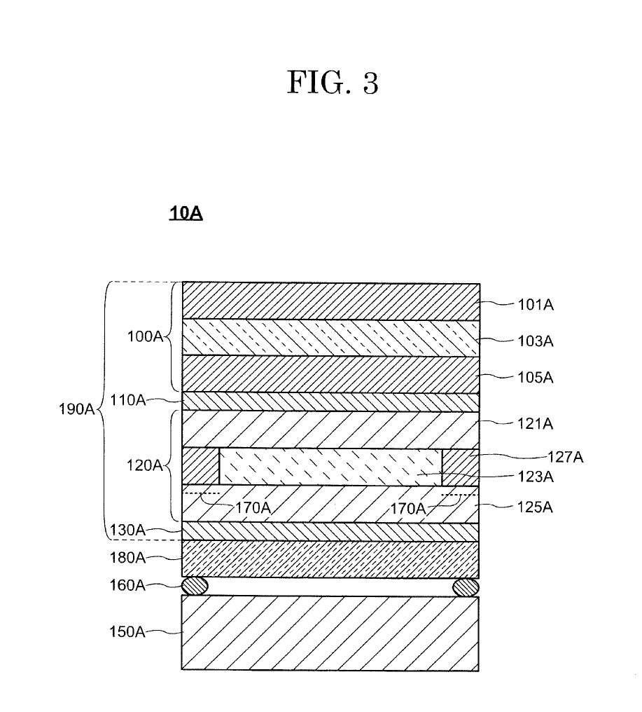

A summary of a liquid crystal display device according to one embodiment of the present invention is explained using FIG. 3. FIG. 3 is a cross-sectional diagram showing the overall structure of a liquid crystal display device according to one embodiment of the present invention. The display device 10A shown in FIG. 3 is similar to the display device 10 shown in FIG. 1 but is different from the display device 10 in that the structure of the second film 180A is different from the structure of the first film 100A.

Unlike the first film 100A, the second film 180A does not include the hard coats 101A and 105A. That is, the second film 180A is formed only of a base material. In the present embodiment, the material of the second film 180A is different from the material of the base material 103A of the first film 100A. In other words, the skeleton of the main material of the base material 103A of the first film 100A is different from the skeleton of the main material of the base material of the second film 180A. The elastic modulus of the second film 180A is higher than the elastic modulus of the base material 103A of the first film 100A.

By adopting the structure described above, it is possible to bring the elastic modulus of the second film 180A closer to the elastic modulus of the first film 100A even if the second film 180A does not include a hard coat.

In the present embodiment, instead of a structure in which the material of the base material 103A of the first film 100A and the material of the second film 180A are different, a structure is possible in which the second film 180A is thicker than the base material 103A. In this case, it is possible to use a film such as a polyimide film or a PET film as the second film 180A, similar to the base material 103A of the first film 100A.

Although an example of a structure was shown in the present embodiment in which the second film 180A does not include a hard coat, the second film 180A is not limited to this structure. For example, a hard coat may be arranged on both sides or one side of the second film 180A.

As described above, in the display device 10A according to the second embodiment, since the second film 180A is adhered to the second polarization member 130A side of the display panel 190A, the neutral face 170A exists within the display cell 120A. Therefore, even when the display device 10A is bended, it is possible to suppress stress being applied to the metal layer, the semiconductor layer and the inorganic insulating layer of the second substrate 125A in the periphery region 194A which overlaps the sealing material 127A in a planar view in particular.

### Third Embodiment

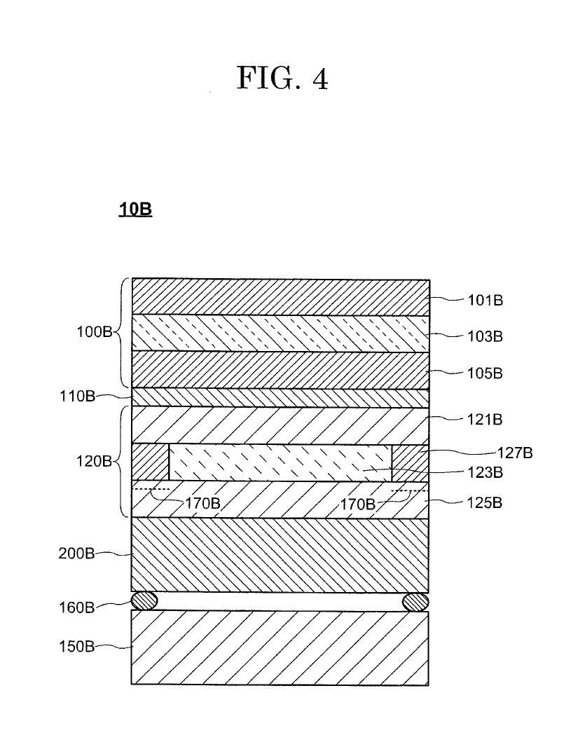

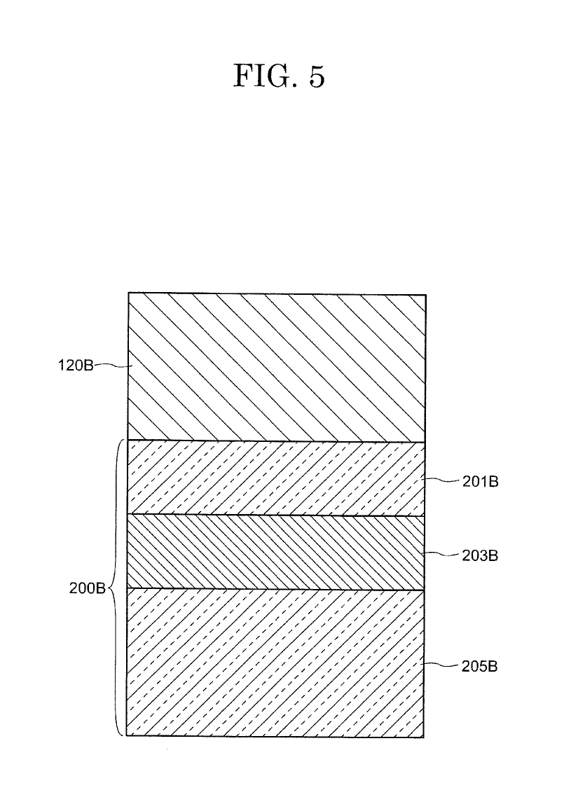

An overview of a liquid crystal display device according to one embodiment of the present invention is explained using FIG. 4 and FIG. 5. FIG. 4 is a cross-sectional diagram showing an overall structure of a liquid crystal display device according to one embodiment of the present invention. Although the display device 10B shown in FIG. 4 is similar to the display device 10 shown in FIG. 1, they are different in that a second polarization member 200B is thicker than the first polarization member 110B, and the second film 140 of the display device 10 is not arranged.

In the present embodiment, the second polarization member 200B is thicker than the first polarization member 110B. The material of the second polarization member 200B is the same as the material of the first polarization member 110B. The elastic modulus of the second polarization member 200B is higher than the elasticity modulus of the first polarization member 110B due to the difference in thickness between the first polarization member 110B and the second polarization member 200B. As a result, a neutral face 170B exists within the display cell 120B. That is, the second polarization member 200B of the present embodiment has a function for adjusting the position of the neutral face 170B similar to the second film 140 of the first embodiment. Therefore, the second film 140 of the first embodiment is equivalent to the second polarization member 200B of the present embodiment. The material of the second polarization member 200B may also be different from the material of the first polarization member 110B.

The structure of the second polarization member 200B is explained in detail using FIG. 5. FIG. 5 is a cross-sectional diagram showing a layer structure of a second polarization member according to one embodiment of the present invention. As is shown in FIG. 5, the second polarization member 200B includes a first protective film 201B, a polarization element 203B and a second protective film 205B. The polarization element 203B is arranged between the first protective film 201B and the second protective film 205B. The second protective film 205B is farther from the display cell 120B than the first protective film 201B. The second protective film 205B is thicker than the first protective film 201B.

Triacetyl cellulose (TAC), polyethylene terephthalate (PET), cycloolefin polymer (COP) or a structure in which these are stacked can be used as the first protective film 201B and the second protective film 205B. It is possible to use polyvinyl alcohol (PVA) as a main component and a material in which iodine (I) compound molecules are adsorbed and oriented as the polarization element.

Although not shown in the diagram, the first polarization member 110B of FIG. 4 also has the same layer structure as the second polarization member 200B. In the first polarization member 110B, the thicknesses of the protective films on both sides of the polarization element are about the same. However, the thicknesses of the protective films on both sides of the polarization element of the first polarization member 110B may also be different. In the present embodiment, the thickness of the first protective film 201B is the same thickness as any one of the protective films of the first polarization member 110B. However, the thickness of the first protective film 201B may also be different from the thickness of the protective films of the first polarization member 110B.

Although not shown in the diagram, a phase difference film may be arranged between the display cell 120B and the second polarization member 200B. Although light which is emitted from the light source is changed into linearly polarized light by the polarization member, linearly polarized light changes into elliptically polarized light by passing through a layer such as a liquid crystal layer for example. The phase difference film has a function for returning the elliptically polarized light to linearly polarized light. The phase difference film is optimized according to the amount of linearly polarized light which changes to elliptically polarized light. Although a member which is closer to the display cell 120B than the polarization element 203B of the second polarization member 200B affects the change from linearly polarized light to elliptically polarized light, a member farther from the display cell 120B than the polarization element 203B has no effect on such a change. Therefore, if the thickness of the second polarization member 200B is increased by making the second protective film 205B thicker, it is possible to adjust the position of the neutral face 170B without changing the conventionally used phase difference film.

It is preferred that the second protective film 205B has a function for changing the polarization of light, that is, has a phase difference. Among the light emitted from the light source of the illumination device 150B toward the second polarization member 200B, light which could not pass through the polarization element 203B of the second polarization member 200B is reflected toward the illumination device 150B. The light which is reflected toward the illumination device 150B is reflected again toward the second polarization member 200B by the illumination device 150B. By providing the second protective film 205B with a phase difference, the probability that light is reflected repeatedly between the illuminating device 150B and the second polarization member 200B and passes through the polarization element 203B increases. Therefore, it is possible to improve the utilization efficiency of light from the illumination device 150.

As described above, according to the display device 10B according to the third embodiment, since the elastic modulus of the second polarization member 200B is higher than the elastic modulus of the first polarization member 110B, the neutral face 170B exists within the display cell 120B. Therefore, even when the display device 10B is bended, it is possible to suppress stress being applied to the metal layer, the semiconductor layer and the inorganic insulating layer of the second substrate 125B in the periphery region 194B which overlaps with the sealing material 127B in a planar view in particular.

### Fourth Embodiment

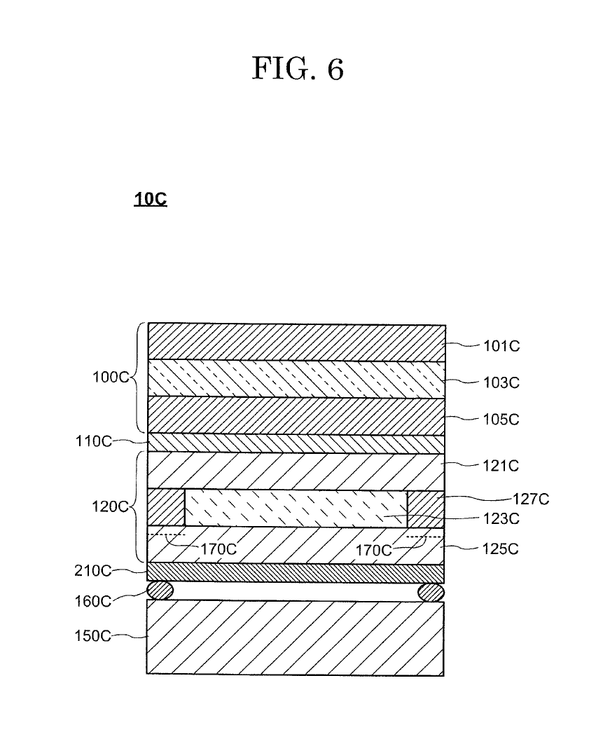

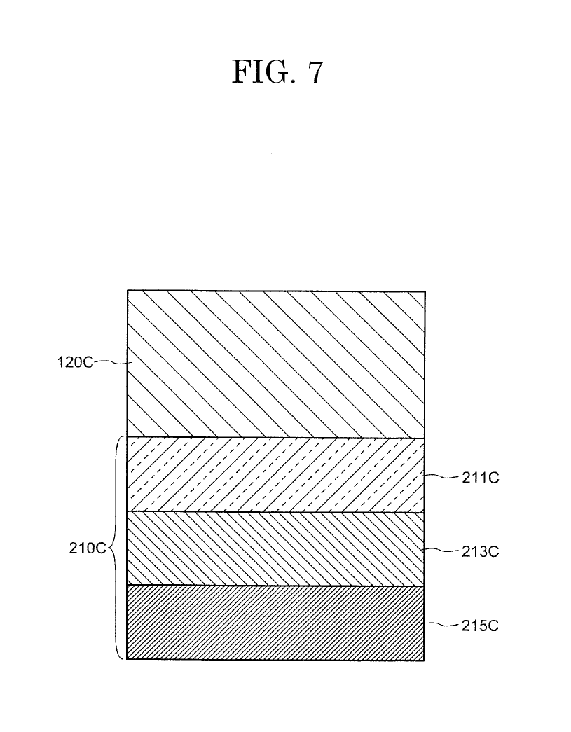

An overview of a liquid crystal display device according to one embodiment of the present invention is explained using FIG. 6 and FIG. 7. FIG. 6 is a cross-sectional diagram showing the overall structure of a liquid crystal display device according to one embodiment of the present invention. Although the display device 100 shown in FIG. 6 is similar to the display device 10B shown in FIG. 4, they are different in that the material of the second polarization member 210C is different from the material of the first polarization member 110C.

In the present embodiment, the material of the second polarization member 210C is different from the material of the first polarization member 110C. Specifically, a material having a higher elastic modulus than the material of the first polarization member 110C is used as the material of the second polarization member 210C. The thickness of the second polarization member 210C is the same as the thickness of the first polarization member 110C. The neutral face 170C exists within the display cell 120C due to the difference in the elastic modulus of the first polarization member 110C and the second polarization member 210C. That is, the second polarization member 210C of the present embodiment has a function for adjusting the neutral face 170C similar to the second film 140 of the first embodiment. Therefore, the second film 140 of the first embodiment and the second polarization member 210C of the present embodiment are equivalent. The thickness of the second polarization member 210C may also be different from the thickness of the first polarization member 110C.

The structure of the second polarization member 210C is explained in detail using FIG. 7. FIG. 7 is a cross-sectional diagram showing a layer structure of a second polarization member according to one embodiment of the present invention. As is shown in FIG. 7, the second polarization member 210C includes a first protective film 211C, a polarization element 213C and a second protective film 215C. The polarization element 213C is arranged between the first protective film 211C and the second protective film 215C. The second protective film 215C is farther from the display cell 120C than the first protective film 211C. The material of the second protective film 215C is different from the material of the first protective film 211C. The elastic modulus of the second protective film 215C is higher than the elastic modulus of the first protective film 211C.

As described above, according to the display device 100 of the fourth embodiment, since the elastic modulus of the second polarization member 210C is higher than the elastic modulus of the first polarization member 110C, the neutral face 170C exists within the display cell 120C. Therefore, even when the display device 100 is bended, it is possible to suppress stress being applied to the metal layer, the semiconductor layer and the inorganic insulating layer of the second substrate 125C in the periphery region 194C which overlaps with the sealing material 127C in a planar view in particular.

### Fifth Embodiment

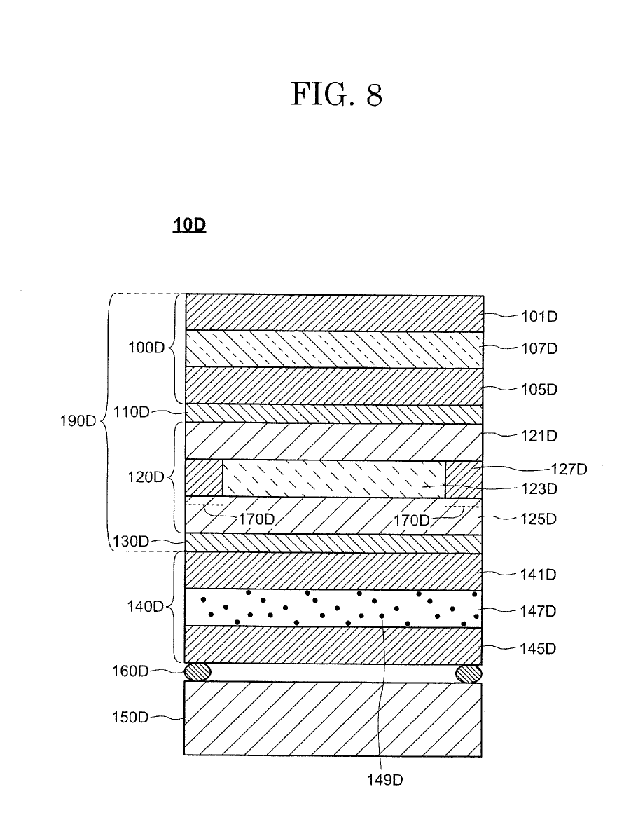

An outline of a liquid crystal display device according to one embodiment of the present invention is explained using FIG. 8. FIG. 8 is a cross-sectional diagram showing the overall structure of a liquid crystal display device according to one embodiment of the present invention. Although the display device 10D shown in FIG. 8 is similar to the display device 10 shown in FIG. 1, they are different in that the base material 147D of the second film 140D includes quantum particles 149D.

Quantum particles 149D means nanoscale particles having unique optical properties according to quantum mechanics. For example, particles which are nanoscale colloid shaped semiconductors and have different band gaps depending on the size of the colloid can be used as the quantum particles 149D. The quantum particles 149D are excited by light from a light source and emit light according to a band gap. That is, the quantum particles 149D function as a color conversion member. It is possible to adjust the color expressed in each pixel by arranging the quantum particles 149D having different band gaps for each pixel. Although a structure is shown in FIG. 8 in which the hard coats 141D and 145D are arranged on both sides of the base material 147D, one or both of the hard coats 141D and 145D may also be omitted.

As described above, according to the display device 10D according to the fifth embodiment, it is possible to obtain the same effects as in the first embodiment and it is possible to provide a display device with higher color purity.

Although a structure is shown in the first to fifth embodiments described above in which the second films 140 and 180A are adhered to the second polarization member 130 side over the entire surface of the display panel 190, or the thickness or elastic modulus of the second polarization members 130, 200B and 210C are different from the first polarization member 110, the present invention is not limited to this structure. For example, in the case when the area to be bent is determined in advance, the structure described above may be applied corresponding to that bent part.

In the first to fifth embodiments described above, the first film 100 and the second films 140, 180A may have barrier properties against gas. In order to provide the film described above with barrier properties against gas, the film may include SiO₂ or SiN. In particular, it is preferred that the film has barrier properties against oxygen and water vapor. By providing the film described above with barrier properties against gas, environmental resistance of the display device 10 is improved.

The first film 100 and the second films 140 and 180A may have conductivity in the first to fifth embodiments described above. In order to provide the films described above with conductivity, the films may include a conductive film and the film itself may have conductivity. By providing the films with conductivity, durability against electrostatic breakage of the display device 10 is improved.

A touch panel may be attached to the first film 100 in the first to fifth embodiments described above. In this case, the elastic modulus of the second films 140, 180A may be adjusted with respect to the elastic modulus in the case when the first film 100 and the touch panel are considered as a single body.

Furthermore, the present invention is not limited to the embodiments described above and can be appropriately modified within a scope that does not depart from the concept of the invention.

What is claimed is:

1. A display device having flexibility comprising:
a display cell including a first substrate having flexibility, a second substrate having flexibility and an electro-optical layer between the first substrate and the second substrate;
a first film adhered to the display cell on the first substrate side of the display cell;
a first polarization member between the first substrate and the first film; and
a second film adhered to the display cell on the second substrate side of the display cell.

2. The display device according to claim 1, wherein the first film exists on a surface of the display device.

3. The display device according to claim 1, further comprising a second polarization member between the second substrate and the second film.

4. The display device according to claim 3, further comprising an illumination device including a light source,
wherein
the second polarization member is a polarization member including a reflecting film; and
the second film exists between the illumination device and the second polarization member.

5. The display device according to claim 3, further comprising:
an illumination device including a light source; and
a display panel including the display cell, the first polarization member, the second polarization member and the first film,
wherein
the display panel includes a display region displaying an image and a periphery region on a periphery of the display region;
the illumination device is fixed to the display panel on the second polarization member side of the display panel via an adhesive; and
the adhesive exists on the periphery region in a planar view.

6. The display device according to claim 5, wherein the adhesive is in a region not overlapping with a part of the display region in a planar view.

7. The display device according to claim 1, wherein
the second film includes a second polarization member, and
the second polarization member is thicker than the first polarization member.

8. The display device according to claim 7, wherein
the second polarization member includes a first protective film, a second protective film separated further from the display cell than the first protective film, and a polarization element between the first protective film and the second protective film, and
a thickness of the second protective film is thicker than a thickness of the first protective film.

9. The display device according to claim 1, wherein the second film includes quantum particles.

10. The display device according to claim 1, wherein a skeleton of a main material of a base of the first film is the same as a skeleton of a main material of a base of the second film.

11. The display device according to claim 1, wherein
a skeleton of a main material of a base of the first film is different to a skeleton of a main material of a base of the second film, and
a modulus of elasticity of the second film is larger than a modulus of elasticity of the first film.

12. A display device comprising:
a display cell including a first substrate having flexibility, a second substrate having flexibility and an electro-optical layer between the first substrate and the second substrate;
a first film adhered to the display cell on the first substrate side of the display cell; and
a first polarization member between the first substrate and the first film,
wherein
a neutral face of stress when the display device is bent exists in the first substrate, in the second substrate or between the first substrate and the second substrate.

13. The display device according to claim 1, wherein the display device is foldable.

14. The display device according to claim 1, wherein the electro-optical layer is a liquid crystal layer.

15. The display device according to claim 2, further comprising a second polarization member between the second substrate and the second film.

16. The display device according to claim 15, further comprising an illumination device including a light source,
wherein
the second polarization member is a polarization member including a reflective film; and
the second film exists between the illumination device and the second polarization member.

17. The display device according to claim 15, further comprising:
an illumination device including a light source; and
a display panel including the display cell, the first polarization member, the second polarization member and the first film,
wherein
the display panel includes a display region displaying an image and a periphery region on a periphery of the display region;
the illumination device is fixed to the display panel on the second polarization member side of the display panel via an adhesive; and
the adhesive exists on the periphery region in a planar view.

18. The display device according to claim 17, wherein the adhesive is in a region not overlapping with a part of the display region in a planar view.

19. The display device according to claim 18, wherein a skeleton of a main material of a base of the first film is the same as a skeleton of a main material of a base of the second film.

20. The display device according to claim 12, wherein the display device is foldable.
